(19) United States
(12) Patent Application Publication
(10) Pub. No.: US 2005/0071274 A1
(43) Pub. Date: Mar. 31, 2005

(54) Method and Apparatus in a Digital Rights Client and a Digital Rights Source and associated Digital Rights Key

(75) Inventors: Marko W. Pfaff, South Elgin, IL (US); Christian Rigg, South Elgin, IL (US); William Vroman, Ingleside, IL (US); Ching Kung, Mount Prospect, IL (US); Himanshu Shekhar, Palatine, IL (US)

Correspondence Address: PATENTS AND LICENSING LLC;DANIEL W. JUFFERNBRUCH, 28 BARRINGTON BOURNE, BARRINGTON, IL, 60010-9605, US

(73) Assignee: UTSTARCOM, INC., Alameda, CA (US)

(21) Appl. No.: 10/605,392

(22) Filed: Sep. 27, 2003

(51) Int. Cl. G06F 17/60; H04L 9/00; H04K 1/00

(52) U.S. Cl. 705/51

(57) ABSTRACT

Permission information (110), including a security parameter index SPI and a digital signature (120), form a digital rights key (140) in a digital rights management system. The security parameter index SPI identifies and algorithm for digital signature calculation (130) and of the digital rights key (140). A digital rights source generates the digital rights key (140) using the security parameter index SPI for digital rights management of licenses to an application. A digital rights client receives the digital rights key (140) and interprets it using an algorithm identified by the security parameter index SPI.

### CROSS REFERENCE TO RELATED APPLICATIONS

The present application is related to U.S. patent application Ser. No. 10/605,376 entitled “Method and Apparatus for Feature Rights Management in a Multilevel Hierarchy” filed on Sep. 25, 2003 by the same inventors as the present application and subject to assignment to the same assignee as the present application; such patent application is hereby incorporated by reference.

### BACKGROUND OF INVENTION

1. Technical Field

The present invention relates to digital rights keys and, more particularly, relates to a software parameter index for use in digital rights keys.

2. Description of the Related Art

Systems have been known for activating digital rights such as in software using digital keys. Digital keys have been used to allow installation of a software application at the time of software installation. Digital keys have also been used to encode classes of rights for digital media file such as music. Digital key mechanisms have also been used to unlock certain software applications or certain features in applications. Digital keys typically use a signature to authenticate a digital key and provide security.

An example of a digital key mechanism used to unlock certain features in software applications is the Total Control 1000 WAN HUB Network Management Card by U.S. Robotics. The U.S. Robotics Total Control 1000 provided for feature upgrades to network management and application cards. Examples of the features to be upgraded were dial security and cellular support as well as future features upgrades. The Total Control 1000 was a chassis consisting of one network management card and up to 16 application cards, each application card providing, for example, analog modem dial-up access lines for an internet service provider ISP. The analog modems on each network application card had features enabled by keys. The Total Control 1000 chassis was capable of receiving keys from a management application connected through a serial port. The management application sent their feature keys over a Simple Network Management Protocol SNMP protocol. These keys were input directly to a card in the Total Control 1000 chassis by a technician. Each key was constructed using the serial number of the destination card, so that it would be tied directly to a serial number of the card which the feature is destined. The Total Control 1000 keys could not be reassigned to other cards. This made card replacement maintenance difficult because keys could not be reused.

### SUMMARY OF INVENTION

A digital rights client decodes a digital rights key having permission information, a security parameter index and a digital signature. A digital signature calculation block receives the permission information and the security parameter index from a received digital rights key and calculates a reference digital signature based on the permission information and the security parameter index. A comparitor validates the digital rights key by comparing at least the digital signature received from the digital rights key with the reference digital signature from the digital signature calculation block.

The details of the preferred embodiments of the invention will be readily understood from the following detailed description when read in conjunction with the accompanying drawings wherein:

### BRIEF DESCRIPTION OF DRAWINGS

FIG. 1 illustrates a diagram of a digital rights key and its creation from constituent parts according to the present invention;

FIG. 2 illustrates a block diagram of a digital rights client according to the present invention;

FIG. 3 illustrates a block diagram of a digital signature calculator according to the present invention;

FIG. 4 illustrates a block diagram of a digital rights source according to the present invention;

FIG. 5 illustrates a block diagram of an application of digital rights keys to a feature rights management system;

FIG. 6 illustrates a diagram of an example of a digital rights key file containing the digital rights keys of the present invention; and

FIG. 7 illustrates an XML file containing digital rights keys.

### DETAILED DESCRIPTION

Use of secrets to secure a communication protocol is known to be used for the generation of communication packets. The secrets were used at the ends of a communication channel to encode and decode packets. The secrets were also used for forming digital signatures to attach to the communication packets for authentication purposes. Systems having these secure communication packets have been known to utilize a Security Parameter Index SPI. The Security Parameter Index SPI was used to match against the SPI of an algorithm for encoding and decoding an entire protocol packet. If the SPIs of communication peers do not match, then the traffic layer packets are invalid. Signatures for authenticating a communication packet and encryption for securing a communication packet are common mechanisms to secure communication transport protocols is disclosed in U.S. Patent Publication No. 20010047487. The IETF standard for IP security known as IPSec is an example of a system which uses SPI for secure IP communication packets.

It is proposed by the present invention to secure applications and their features with application license rights permissions provided by a digital rights key that uses, among other things, a security parameter index SPI to identify the algorithm used to protect the key. In the present invention the Security Parameter Index SPI points to an algorithm for generating and interpreting at least a digital signature portion of a digital rights key.

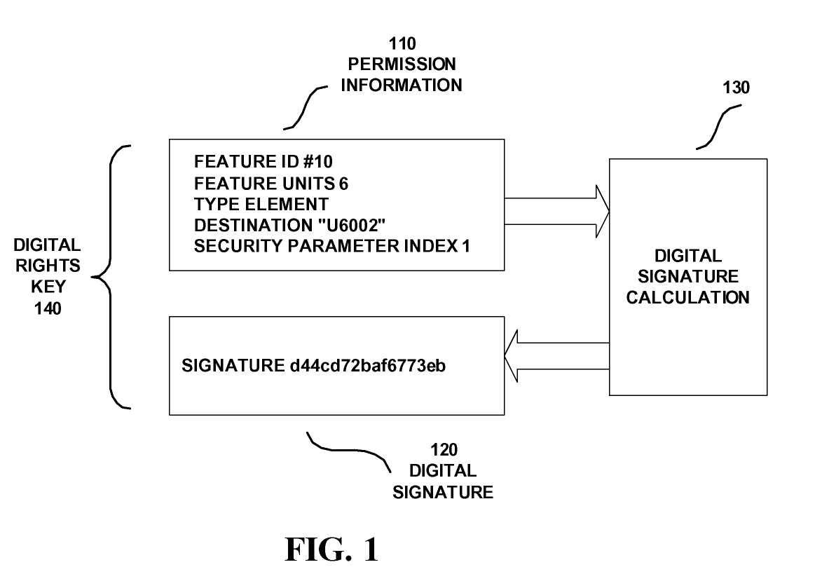

FIG. 1 illustrates a diagram of a digital rights key 140 and its creation from constituent parts. The digital rights key 140 contains permission information 110 and a digital signature 120. The permission information 110 contains a feature ID, a number of feature units, a destination identifier (such as a server or agent serial number or identifier), a type designation of either element or network, and a security parameter index SPI. A digital signature calculation 130 is preferably a hash or encryption function, or alternative cryptographic algorithm, used to calculate the digital signature 120. The security parameter index SPI can be contained in the permission information 110 to identify one of the different kinds of the hash or encryption functions 130 used to calculate the digital signature 120.

The digital signature 120 provides security for the digital rights key 140. The permission information 110 is provided in clear text and is input for the digital signature calculation 130 which produces the digital signature 120. Any attempt to manipulate the contents of the permission information 110 will result in a mismatch of the digital signature when verified at an agent or server. In this case the digital rights key would be considered invalid and discarded. The digital signature 120 also ensures that the originator of the digital rights key is the equipment provider. Once the server or agent that receives the key verifies the digital signature 120, the permission information 110 can be read in clear text.

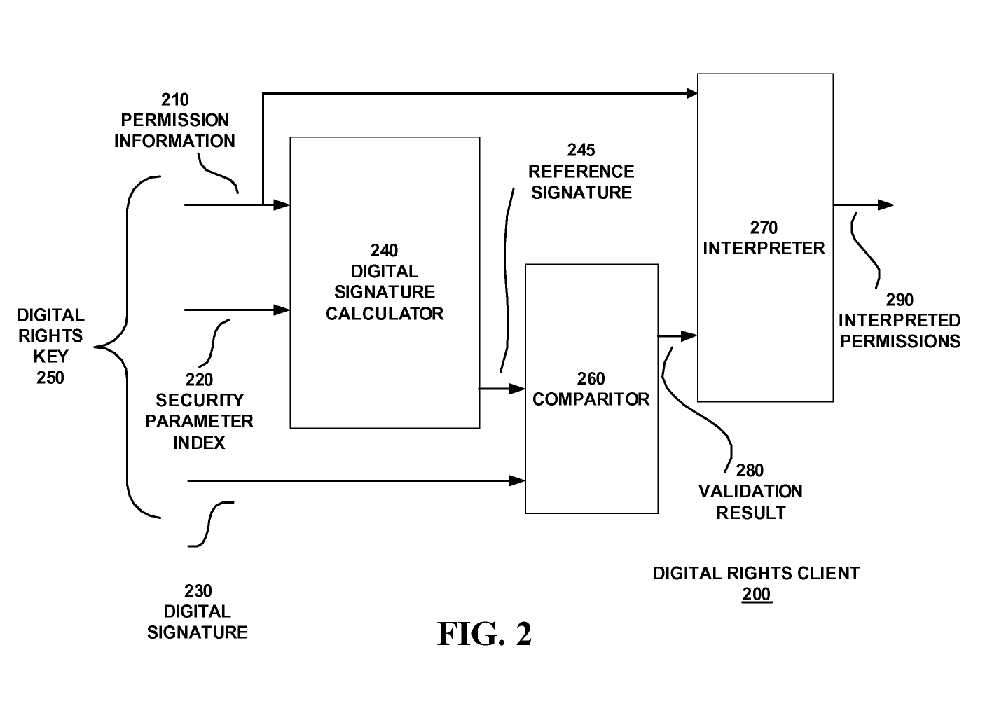

FIG. 2 illustrates a block diagram of a digital rights client 200 according to the present invention. The digital rights client 200 receives the digital rights key 250. The digital rights key 250 is made up of the permission information 210, the security parameter index 220 and the digital signature 230. A digital signature calculator 240 generates a reference signature 245 using a particular authentication algorithm. The particular algorithm, such as a kind of hash function, is chosen by the value of the security parameter index 220. The security parameter index 220 of the present invention provides for digital rights management of application software and media content in a flexible way. Backward compatibility and equipment upgrades are also facilitated by virtue of placing the security parameter index in the digital rights key.

The reference signature 245 output from the digital signature calculator 240 is compared in a comparator 260 against the digital signature 230 from the digital rights key 250. When the comparator 260 indicates a match between the reference signature 245 and the digital signature 230, the digital rights key 250 is confirmed as valid on the validation result signal 280.

An interpreter 270, upon a valid validation result signal 280 from the comparator 260, provides interpreted permissions 290 based on the permission information 210. The permission information 210 according to one preferred embodiments of the present invention is sent in clear text. It is understood that the permission information, instead of been sent in clear text, can be encoded or encrypted with the digital signature. Because the comparison of the digital signature 230 with the reference signature 245 in the comparator 260 validates the key, and may not be necessary to further protect the permission information.

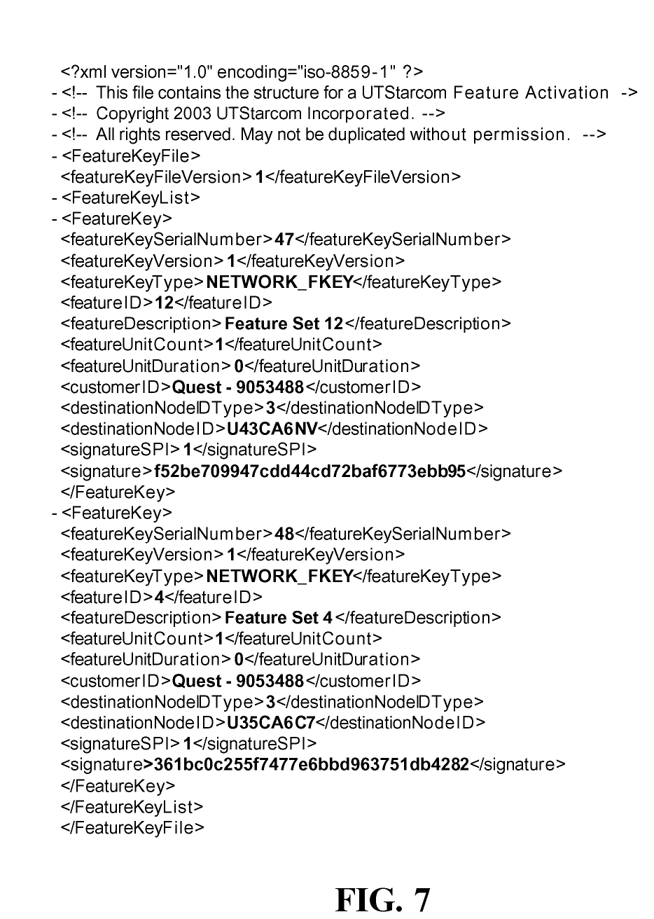

An XML decoder can be provided, in a further embodiment, connected to inputs of the digital signature calculation block 240 and the comparator 260. The XML decoder identifies XML tags, as illustrated in FIG. 7, and parses the digital rights key 250 into the permission information 210 for the digital signature calculation block, the security parameter index 220 for the digital signature calculation block, and the digital signature 230 in the digital rights key 250 for the comparator 260.

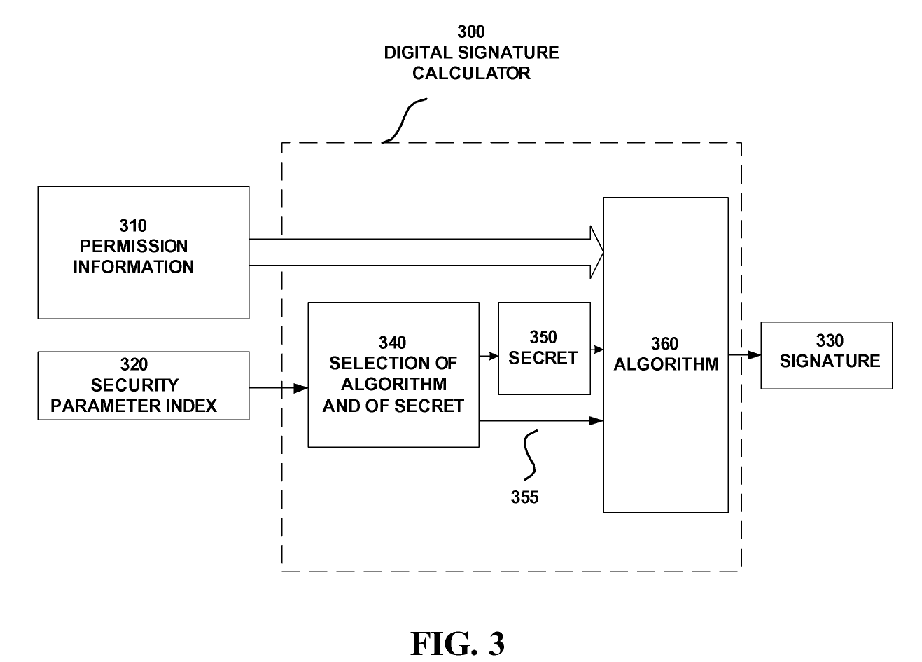

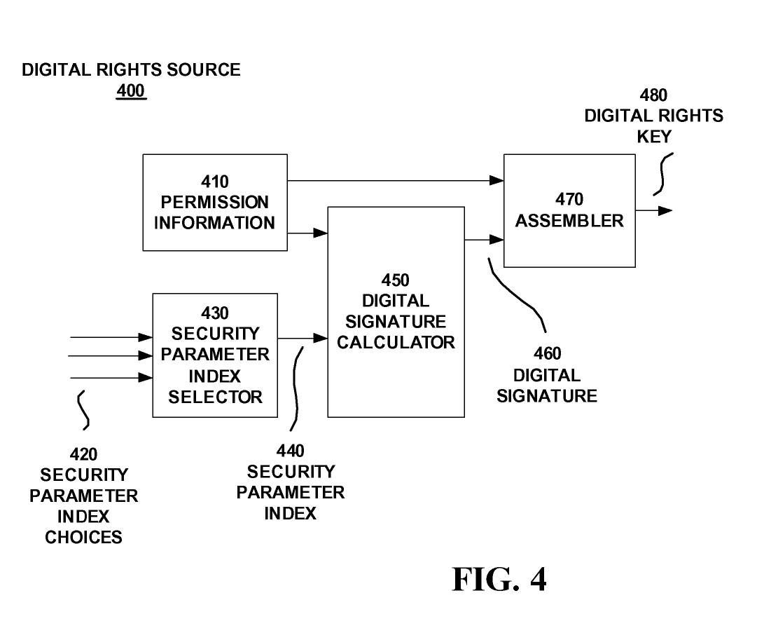

FIG. 3 illustrates a block diagram of the digital signature calculator 300 according to the present invention. The digital signature calculator of FIG. 3 illustrates an exemplary construction of the digital signature calculation performed by a digital rights client by a digital rights source. The digital signature calculator 300 receives permission information 310 and of the security parameter index 320. Based on the security parameter index 320, a selection of an algorithm, such as a kind of hash function, is performed in block 340. Although the security parameter index 320 in one embodiment is used to identify only the algorithm, in another embodiment, as illustrated in FIG. 3, a selection of the secret is also performed in block 340. The selected secret 350 together with a signal 355, which identifies the selected algorithm, is then sent to the algorithm 360 for calculation. The result of the calculation in the algorithm 360 is a signature 330. This signature 330 can be used either in the digital rights client 200 of FIG. 2 or in the digital signature calculator 300 which will now be described with reference to FIG. 4.

FIG. 4 illustrates a block diagram of a digital rights source 400 according to the present invention. The digital rights source 400 generates a digital rights key for a digital rights management system. A security parameter index selector 430 chooses one of a plurality of security parameter index choices 420. The choice made by the security parameter index selector 430 then provides the security parameter index SPI for the digital rights key generated by the digital rights source 400 of FIG. 4. A digital signature calculator 450 calculates the digital signature 460 using the kind of algorithm identified by the security parameter index 440. The digital signature calculator 450 applies the chosen algorithm to the permission information 410. Application of the chosen algorithm to the permission information in the digital signature calculator is preferably performed with reference to the secret. The secret is a trusted code present at both the digital rights source and a digital rights client that is used for digital signature calculation by the algorithm identified by the security parameter index. A digital signature 460 is then generated for assembly with the permission information 410. The assembler 470 assembles the permission information 410 with the digital signature 260 to create the digital rights key 480. This digital rights key 480 authorizes license rights to applications including application features and media such as movies, and the like, using the security parameter index of the digital rights key for digital rights management according to the present invention.

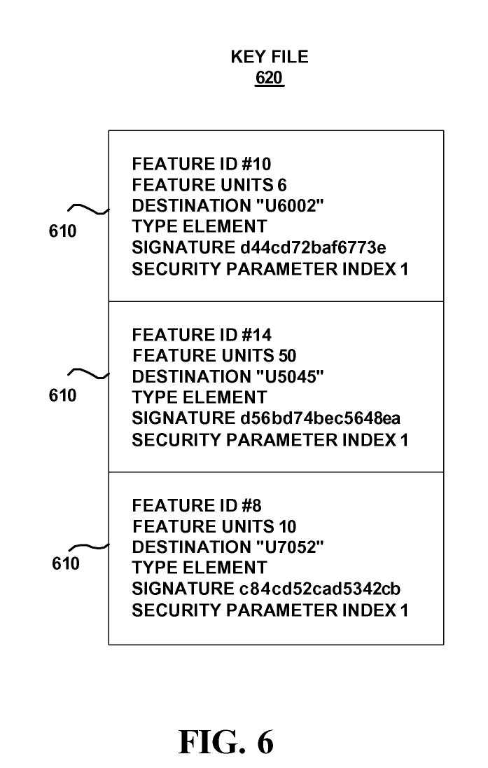

In a further embodiment the assembler 470 can contain an XML encoder. The XML encoder applies XML tags to portions of the permission information and to the digital signature assembled to produce the digital rights key 480. The XML encoder also provides tags surrounding the digital rights key as illustrated in FIG. 7 and allows multiple digital rights key to be parsed together and form a digital rights file as will be described with respect to FIG. 6.

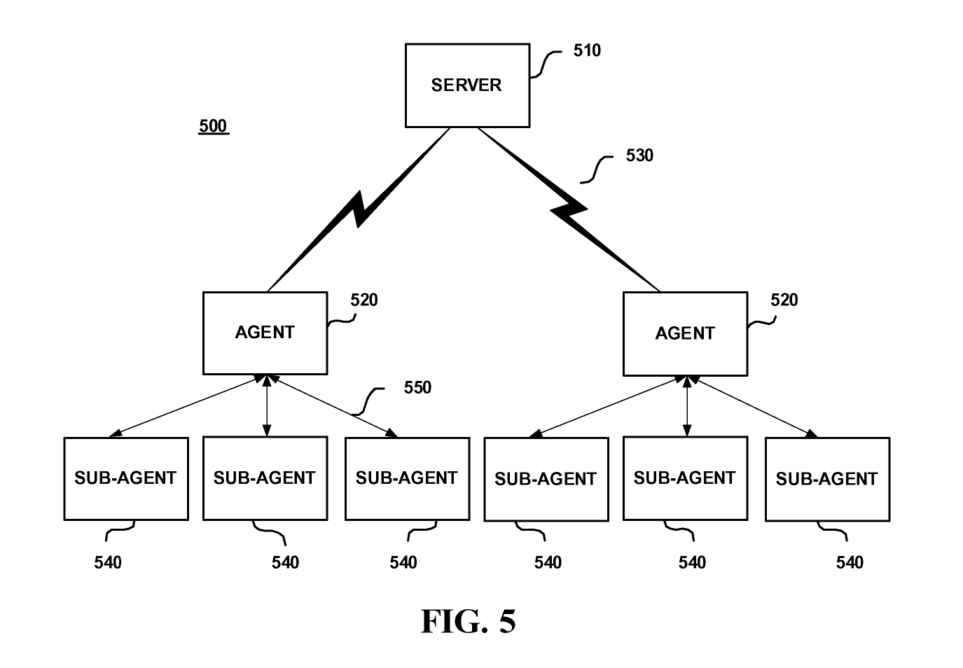

FIG. 5 illustrates a block diagram of an application of digital rights keys to a feature rights management system 500 having a multilevel hierarchy. A number of feature rights management agents 520 are coupled over a network 530 to a feature rights server 510. The feature rights server 510 contains a memory for storing network digital rights keys. Each network digital rights key represents rights for features that are stored in the feature rights management server 510 for subsequent allocation to any feature rights management agent 520 in the operator's network.

A plurality of sub-agents 540 are connected over a bus 550 to its corresponding feature rights management agent 520. In a telecommunications deployment, each feature rights management agent 520 is typically located in one facility among a plurality of sub-agents 540. A plurality of sub-agents 540 can be located in a single chassis and share a common bus on a backplane of a chassis or the plurality of sub-agents 540 can be located in multiple chassis all communicating with a single feature rights management agent 520 over a networked bus such as an ethernet bus. The plurality of sub-agents 540 and corresponding agents 520 can even be connected over a networked bus rather than a backplane bus without any chassis. This arrangement might exist within a single general purpose computing platform such as a UNIX server when the capabilities of a single server can support the application demands of a system.

An operator obtains digital rights keys, designated as network keys, from an equipment provider and stores these digital rights keys in the feature rights server 510. Each digital rights key designates a kind of feature, a number of permissible units for that feature, and a destination ID such as a serial number for the server to which the feature is permitted. Each kind of feature can designate a single feature or preferably groups of features. Element keys are also generated by the server 510 with a designation of a kind of feature, a number of permissible units for that feature, and a destination ID such as a serial number for the agent to which the feature is permitted. A digital signature is also contained in each digital rights key regardless of whether or not it is a network key or an element key. The feature rights server 510 is a repository for digital rights keys which have not yet been used to activate features.

An example of a feature of an application to be licensed by a digital rights key is prepaid billing. Telecommunication calls are typically billed after a call is made. A new kind of payment for telecommunications calls occurs in advance. This prepaid billing feature can be set up as a feature requiring a digital rights key before a prepaid billing feature is permitted in the software of the sub-agent 540. The number of permissible units for this feature would designate the number of application cards that are permitted to use this prepaid billing feature. Alternatively the number of permissible units for this feature can designate the number of simultaneous telephone calls that are permitted using this prepaid billing feature.

When an operator desires to provision or activate equipment, activation of the equipment is initiated in the facility at a sub-agent 540. The sub-agent 540 then requests permission from the feature rights management agent 520 to activate a kind of feature and a requested number of units for that feature. The feature rights management agent 520, upon receiving a request from a sub-agent 540, checks to see a number of available feature units for a particular feature stored in its memory. If the feature rights management agent 520 needs more rights than are stored in its memory, the agent 520 sends a request to the feature rights server 510 to obtain more digital rights keys. The feature rights server 110 then subtracts units from its available digital rights keys, assembles element keys and sends these thus assembled element digital rights keys to the requesting feature rights management agent 520. The feature rights management agent 520 then subtracts units from its available allocation of feature units and sends an authorization to the requesting sub-agent 540.

For a feature of a telecommunications application, when a sub-agent 540 is on standby between calls, its feature rights are retained within the sub-agent. When a sub-agent is re-provisioned or re-activated, such as when an application card is replaced or re-deployed, its feature rights can be released from the sub-agent 540 to the feature rights management agent 520. The agent 520 stores those rights for redeployment to other sub-agents 540 or release to the feature rights server 510. When the feature rights management agent 520 stores rights for redeployment, the feature rights management agent 520 can store the rights for redeployment to any sub-agent 540. In the case of a chassis arrangement, when an application card sub-agent is replaced in a slot of a chassis, unless the chassis has been re-provisioned, rather than store the rights for redeployment to any sub-agent 540, it is desired for the feature rights management agent 520 to store those rights associated with the slot in the chassis. Then, when a replacement application card arrives in the slot, the same rights are allocated to that sub-agent.

The agent 520 and the sub-agent 540 do not require authenticated keys in order to authorize features for operation in the sub-agents 540. While the connection between the feature rights server 510 and the plurality of agents 520 requires authenticated keys, the relationship between the plurality of sub-agents 540 and its respective agent 520 is a trusted relationship and does not require authenticated keys. The agent 520 allocates rights among its sub-agents 540 as needed without an accounting to the feature rights server 510 other than the number of units and kind of features activated. The feature rights server 510 still knows which agents 520 obtained rights.

It is not contemplated in this application, however, that the feature rights server 510 has the power to revoke rights, nor is it contemplated that the feature rights management agents 520 have the power to revoke rights. Rather, rights are released voluntarily by the sub-agents 540 and returned back to their respective feature rights management agents 520 when no longer needed. The sub-agents 540 release rights when no longer needed to perform its provisioned operation. Provisioning of the sub-agents 540 occurs by operator intervention over a protocol or command line interface. The feature rights server 510 does not re-provision the feature rights management agents or sub-agents or require release of rights. Once provisioned, sub-agents request keys to activate features via the multilevel hierarchy of the present invention.

FIG. 6 illustrates a diagram of an example of the digital rights key file 620 containing the digital rights keys of the present invention. A plurality of digital rights keys 610 makeup a digital rights key file 620. Each digital rights key contains a security parameter index SPI to identify the kind of hash or encryption function used to encode and decode the digital signature. Each digital rights key 610 also contains a feature ID, a number of feature units, a destination identifier (such as a serial number or identifier for a feature server or feature rights management agent), a type designation of either element or network and a digital signature.

Because the relationship between the feature rights management agent and sub-agent is trusted, permissions and not keys are communicated between the agent and sub-agents. These permissions do not contain a destination identifier or a digital signature because they do not need the extra security provided by them in a key. The digital rights key file 620 can be encoded using Extensible Markup Language XML which provides a containment mechanism where each key 610 and its contents are uniquely identified by XML tags as illustrated with respect to FIG. 7.

The feature rights server 510 is allowed to divide the feature units provided for in a key 610. For example, six feature units for a Feature ID of 10 can be allocated among two agents 520. For instance, a first agent 520 may receive three feature units for the feature ID 10 and a second agent 520 may receive one feature unit for this Feature ID 10 while the feature rights server 510 retains the remaining two feature units for the illustrated Feature ID 10. Once the feature rights server divides the units, it assembles a digital rights key 610 with a type designation of “element” as illustrated in FIG. 6. The “element” type designation identifies that the digital rights key now assembled by the feature server is a key for a feature rights management agent. The key 610 assembled by the feature rights server also specifies a destination ID for the feature rights management agent, the number of feature quantity units and the feature type designation of the key. The feature rights management agent does not assemble digital rights keys for delivery to the sub-agents. The feature rights management agent just provides permission to the sub-agents. Nevertheless, when the feature rights management agent returns feature rights to the feature server, the feature rights management agent assembles a key for their return.

The digital signature of each digital rights key 610 is calculated using a hash function on the feature ID, feature units and destination identifier. This digital signature also provides a secure authentication with the key source and also provides the same benefits as a checksum. The hash function can be any function that takes message authentication codes and combines them with a secret keyword. One preferred example of a hash function is the MD5 Keyed-Hash Message Authentication Code (HMAC MD5) and other kinds such as HMAC SHA-1 or HMAC RIPEMD can be used.

Element keys are assembled for communication between the feature rights server and an agent. Network keys are loaded into the feature rights server when provided by an equipment supplier. Because the relationship between the feature rights management agent and the sub-agent is a trusted relationship, a digital signature is not needed for communication of rights between the feature rights management agent and sub-agent. Thus keys are not needed and mere permissions can be communicated between a feature rights management agent and its sub-agents.

FIG. 7 illustrates an XML file containing digital rights keys. The permission information and the digital signature are encoded using XML which provides a hierarchical containment mechanism. XML is the extensible markup language. In the example of FIG. 7, a single key file contains multiple feature activation keys. Each key is uniquely identified by the XML tag <FeatureKey> and the corresponding end tag </FeatureKey>. Within each key various XML tags identify components of the permission information such as, for example, the serial number, the key version, a network or element type, a feature ID, a feature description, a count of a number of units for a feature, a customer ID, a node ID type, a node ID identifier such as, for example, a serial number, and finally the security parameter index SPI of the present invention.

Although the invention has been described and illustrated in the above description and drawings, it is understood that this description is by example only, and that numerous changes and modifications can be made by those skilled in the art without departing from the true spirit and scope of the invention. Although the examples in the drawings depict only example constructions and embodiments, alternate embodiments are available given the teachings of the present patent disclosure. For example the illustrated blocks do not need to be implemented in distinct hardware configurations. Additionally, while the invention has been illustrated as equipment deployed by an operator, other kinds of users can benefit from the present invention besides telecommunications operators.

1. A digital rights client for decoding a digital rights key, the digital rights key having permission information, a security parameter index and a digital signature, the digital rights client comprising:
a digital signature calculation block operative to receive the permission information and the security parameter index from a received digital rights key and to calculate a reference digital signature based on the permission information and the security parameter index; and
a comparitor operatively coupled to the digital signature calculation block to validate the digital rights key by comparing at least the digital signature received from the digital rights key with the reference digital signature from the digital signature calculation block.

2. A digital rights client according to claim 1,
wherein the comparitor generates a validation indication; and
wherein the digital rights client further comprises an interpreter operatively coupled to the comparitor to interpret the permission information received in the digital rights key and to grant use of digital rights based on the validation indication in accordance with contents of the permission information.

3. A digital rights client according to claim 2,
wherein the digital rights key has permission information in clear text; and
wherein the interpreter interprets the clear text to grant use of digital rights based on the validation indication.

4. A digital rights client according to claim 2,
wherein the permission information of the digital rights key comprises a destination identifier; and
wherein the interpreter grants use of particular feature ID digital rights based on the validation indication and a comparison of the destination identifier.

5. A digital rights client according to claim 2,
wherein the permission information of the digital rights key comprises a feature ID and a number of feature units; and
wherein the interpreter grants use of particular feature ID digital rights based on the validation indication and a comparisons of the feature ID and a number of feature units.

6. A digital rights client according to claim 2,
wherein the permission information of the digital rights key comprises a type designation; and
wherein the interpreter grants use of particular feature ID digital rights based on the validation indication and a comparison of the type designation.

7. A digital rights client according to claim 1, wherein the comparitor is operatively coupled to the digital signature calculation block to validate the digital rights key by comparing the digital signature received from the digital rights key and the reference digital signature from the digital signature calculation block.

8. A digital rights client according to claim 7,
wherein the digital rights key has permission information in clear text; and
wherein the interpreter interprets the clear text to grant use of digital rights based on the validation indication.

9. A digital rights client according to claim 1, further comprising an XML decoder operatively coupled to the digital signature calculation block and the comparator to identify XML tags and parse the digital rights key into the permission information for the digital signature calculation block, the security parameter index for the digital signature calculation block, and the digital signature in the digital rights key for the comparator.

10. A digital rights key, comprising:
a permission information portion for identifying digital rights permitted by the digital rights key;
a digital signature portion; and
a security parameter index portion identifying a secret and an identified algorithm to be used by a digital rights client for interpreting at least the digital signature portion.

11. A digital rights key according to claim 10, wherein the permission information of the digital rights key is in clear text.

12. A digital rights key according to claim 10, wherein the permission information of the digital rights key comprises a destination identifier.

13. A digital rights key according to claim 10, wherein the permission information of the digital rights key comprises a feature ID and a number of feature units.

14. A digital rights key according to claim 10, further comprising XML tags adjacent to the permission information portion, the digital signature portion and the security parameter index portion to identify individual elements of the digital rights key.

15. A digital rights key according to claim 14, wherein the XML tags comprise:
a permission information portion begin tag and a permission information portion end tag at respective ends of the permission information portion;
a digital signature portion begin tag and a digital signature portion end tag at respective ends of the digital signature portion;
a security parameter index portion beginning tag and a security parameter index portion end tag at respective ends of the security parameter index portion; and
a key begin tag and a key end tag, at respective ends of the key, and encompassing said permission information portion begin tag and the permission information portion end tag, said digital signature portion beginning tag and the digital signature portion end tag, and said security parameter index portion beginning tag and the security parameter index portion end tag.

16. A digital rights source for encoding a digital rights key, the digital rights key having permission information, a OLE_LINK1 security parameter index OLE_LINK1 and a signature, the digital rights source comprising:
a selector for selecting a security parameter index among a plurality of security parameter indexes;
a digital signature calculation block operatively coupled to the selector to receive the selected security parameter index and to calculate a digital signature using the selected security parameter index and permission information; and
an assembler operatively coupled to the digital signature calculation block to assemble the digital rights key using the calculated digital signature and permission information.

17. A digital rights source according to claim 16,
wherein the digital rights key has permission information in clear text; and
wherein the assembler assembles the digital rights key using at least the clear text permission information; and
wherein the digital signature calculation block calculates the digital signature using at least the clear text permission information.

18. A digital rights source according to claim 16,
wherein the permission information of the digital rights key comprises a destination identifier; and
wherein the assembler assembles the digital rights key using at least the destination identifier.

19. A digital rights source according to claim 16,
wherein the permission information of the digital rights key comprises a feature ID and a number of feature units; and
wherein the assembler assembles the digital rights key using at least the feature ID and a number of feature units.

20. A digital rights source according to claim 16,
wherein the permission information of the digital rights key comprises a type designation; and
wherein the assembler assembles the digital rights key using at least the type designation.

21. A digital rights source according to claim 16,
wherein the Assembler comprises an XML encoder operatively coupled to the digital signature calculation block and to receive the permission information to provide XML tags surrounding the permission information and the digital signature to produce at least one digital rights key.
